(19) United States
(12) Patent Application Publication
(10) Pub. No.: US 2023/0255357 A1
(43) Pub. Date: Aug. 17, 2023

(54) BUTTOCKS ELEVATING AUXILIARY SEAT CUSHIONING SYSTEM

(71) Applicant: Stephen Lavitol, Lyndhurst, NJ (US)

(72) Inventor: Stephen Lavitol, Lyndhurst, NJ (US)

(21) Appl. No.: 17/672,157

(22) Filed: Feb. 15, 2022

(51) Int. Cl. A47C 7/02; A47C 7/42

(52) U.S. Cl. CPC A47C 7/021; A47C 7/425

(57) ABSTRACT

A buttocks elevating auxiliary seat cushioning system includes a chair having a seat and a backrest that is attached to and extends upwardly from the seat. The seat has an upper surface angled downwardly toward the backrest. A cushion assembly is positioned on the upper surface of the seat and abuts the backrest. The cushioning assembly has a top side, a front side, a rear side, a first lateral side, a second lateral side and a bottom side. The top side is angled upwardly from the front side to the rear side when the bottom side is abutted against the seat and the rear side is abutted against the backrest. The cushion assembly is resiliently compressible.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to seat cushion device and more particularly pertains to a new seat cushion device for assisting in the reduction of pressure placed upon a person's lower spine while seated in a vehicle.

### (2) Description of Related Art Including Information Disclosed Under 37 CFR 1.97 and 1.98

The prior art relates to seat cushion devices that are used to enhance the overall comfort of a chair but which do not prevent lower back pain associated with sitting in a vehicle chair for an extended period of time.

### (h) BRIEF SUMMARY OF THE INVENTION

An embodiment of the disclosure meets the needs presented above by generally comprising a chair having a seat and a backrest that is attached to and extends upwardly from the seat. The seat has an upper surface angled downwardly toward the backrest. A cushion assembly is positioned on the upper surface of the seat and abuts the backrest. The cushioning assembly has a top side, a front side, a rear side, a first lateral side, a second lateral side and a bottom side. The top side is angled upwardly from the front side to the rear side when the bottom side is abutted against the seat and the rear side is abutted against the backrest. The cushion assembly is resiliently compressible.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a buttocks elevating auxiliary seat cushioning system according to an embodiment of the disclosure.

FIG. 2 is a top view of an embodiment of the disclosure.

FIG. 3 is a side view of an embodiment of the disclosure.

FIG. 4 is a top isometric view of a second embodiment of the disclosure.

FIG. 5 is a side view of the second embodiment of the disclosure.

FIG. 6 is a side in-use view of an embodiment of the disclosure.

### (j) DETAILED DESCRIPTION OF THE INVENTION

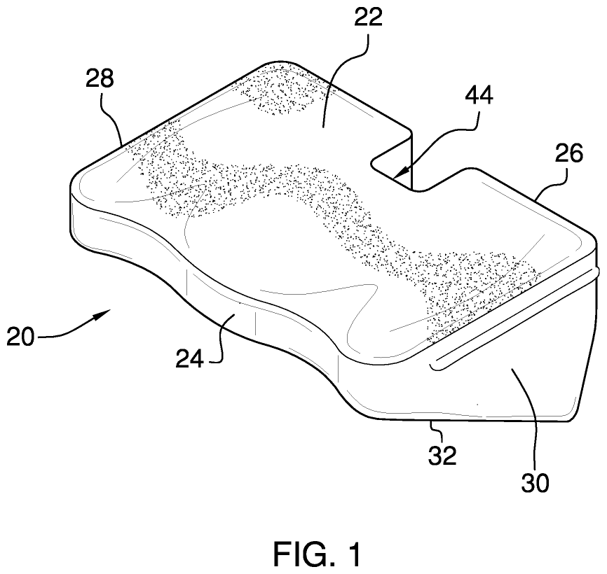

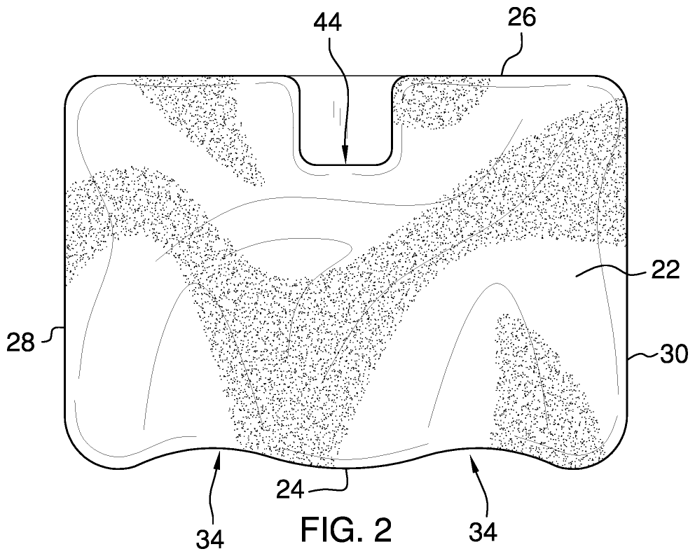

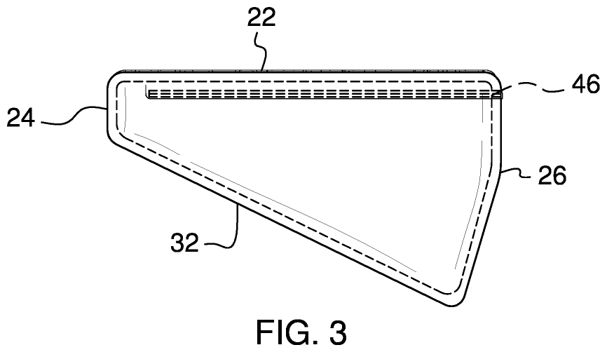

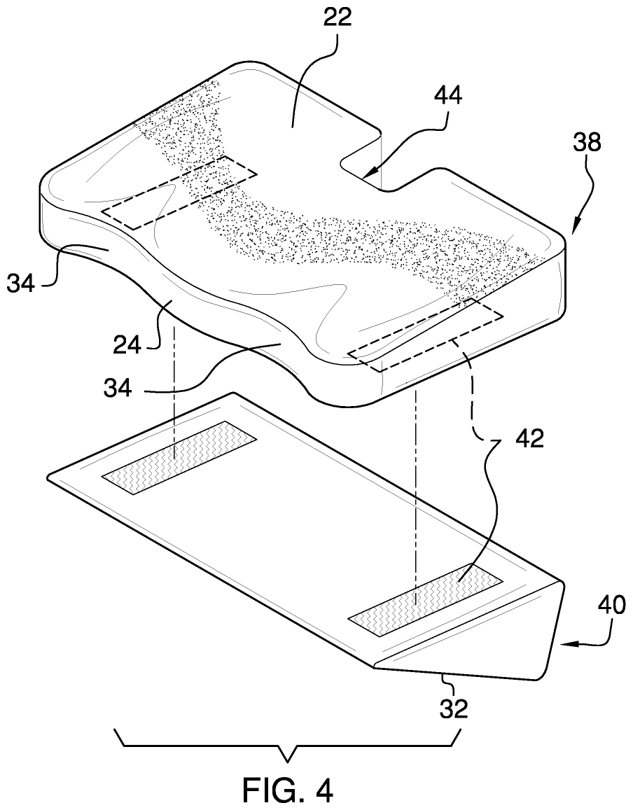

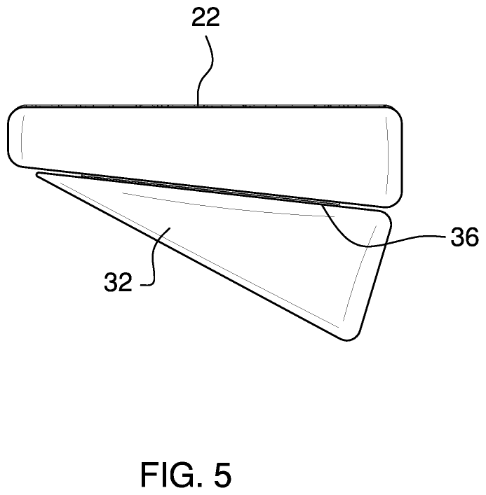

With reference now to the drawings, and in particular to FIGS. 1 through 6 thereof, a new seat cushion device embodying the principles and concepts of an embodiment of the disclosure and generally designated by the reference numeral 10 will be described.

As best illustrated in FIGS. 1 through 6, the buttocks elevating auxiliary seat cushioning system 10 generally comprises a chair 12 that has a seat 14 and a backrest 16 that is attached to and extends upwardly from the seat 14. The seat 14 has an upper surface 18 angled downwardly toward the backrest 16. The chair 12 is generally conventional to passenger vehicles such as cars and trucks but may also be a chair commonly found on airplanes, trains and the like. Thus the backrest 16 and seat 14 may also be pivotally coupled to each other. Often the chair is that of a driver's seat of a vehicle where the person's position is relatively retained in a static position. Vehicles, for comfort purposes, often have chairs that slope downwardly toward the backrest 16 to intentionally pull the person's buttocks and lower back against the backrest 16 due to gravitational forces and thereby contour the chair 12 to the person. However, this positioning can cause strain on the lower back as such positioning typically results in the person's knees being higher than their lower back and buttocks.

A cushion assembly 20 is positioned on the upper surface 18 of the seat 14 and abuts the backrest 16. The cushioning assembly 20 has a top side 22, a front side 24, a rear side 26, a first lateral side 28, a second lateral side 30, and a bottom side 32. The top side 22 is angled upwardly from the front side 24 to the rear side 26 when the bottom side 32 is abutted against the seat 14 and the rear side 26 is abutted against the backrest 16. Thus, when a person sits upon the cushion assembly 20, their buttocks is raised relative to their knees to relieve strain on the lower back. The cushion assembly 20 is resiliently compressible and comprised of any conventional material, and in particular foamed materials, used for seat cushions. The type and specifications of materials used may also be determined by user preferences as some may require or find preferential firmer materials than others.

The front side 24 has a height from the top side 22 to the bottom side 32 typically less than 2.0 inches and may be equal to or less than about 1.5 inches. The front side 24 will have a relatively lower height than the rear side to prevent an uncomfortable lip from being formed under a person's legs while the person is seated on the cushion assembly as well as ensure that the person's buttocks will be raised higher on the seat 14. The rear side 26 typically has a height from the top side 22 to the bottom side 32 that is greater than 6.0 inches. The rear side 26 height may vary depending on the slope of the upper surface 18 of the seat 14 as well as the compressibility of the materials found within the cushion assembly 12.

A distance from the first lateral side 28 to the second lateral side 30 is between 14.0 inches and 20.0 inches, and a distance from the front side 24 to the rear side 26 is between 11.0 inches and 17.0 inches. The size of the top side 22, in particular, may be altered depending on the size of the chair 12 as well as the size of the person to be seated upon the chair 12.

The front side 24 may include a pair of concave indentations 34 therein. The concave indentations 34 are laterally spaced from each other and form concave arcs in each of the top 22 and bottom 32 sides. The concave arcs each have a length extending along the front side between 3.0 inches and 6.0 inches and aid in providing comfort for the user's legs.

In one embodiment, the cushion assembly 20 has a break 36 therein to define an upper section 38 and a lower section 40. The break 36 extends through the rear side 26 to a juncture of the front side 22 and the bottom side 32. The rear side 26 of the upper section 38 has a height is greater than 2.0 inches, and, as can be seen in the Figures, the height of the upper section 38 decreases from the rear side 26 to the front side 24. A coupler 42 releasably couples the upper section 38 to the lower section 40. The coupler 42 may comprise any conventional mechanical coupler and though a hook and loop coupler is shown in the Figures, magnets, snaps, buttons, zippers and similar structures may be utilized as well as straps including the above positioned on the first 28 and second lateral sides of the upper 38 and lower 40 sections.

A cutout 44 extends into the rear side 26 and through the top side 22. The cutout 44 is equally spaced from the first 28 and second 30 lateral sides and extends into the rear 26 and top 22 sides and toward the front side 24 a distance of less 4.0 inches but more than 1.0 inches. The cutout 44 has a width extending along the rear side 26 is between 2.0 inches and 5.0 inches. The cutout 44 functions as a pressure point relief area for a person's tailbone such that the tailbone does not contact any portion of the cushion assembly 20.

As mentioned above, the cushion assembly 20 may be comprised of any conventional compressible material used in cushions. It should be understood that the upper 38 and lower 40 sections may include different types of materials to allow the user to alter the overall compressibility of the assembly. The cushioning material is typically encased in a covering material and may include a zipper 46 for accessing the cushioning material to allow for changing the cushioning material and to remove the covering material completely for cleaning. The covering material may be any conventional material though materials that resist slipping on the cushioning material are favored. Softer materials, such as those conventional known as “Sherpa” cloth comprised of cotton may be favored for their comfort.

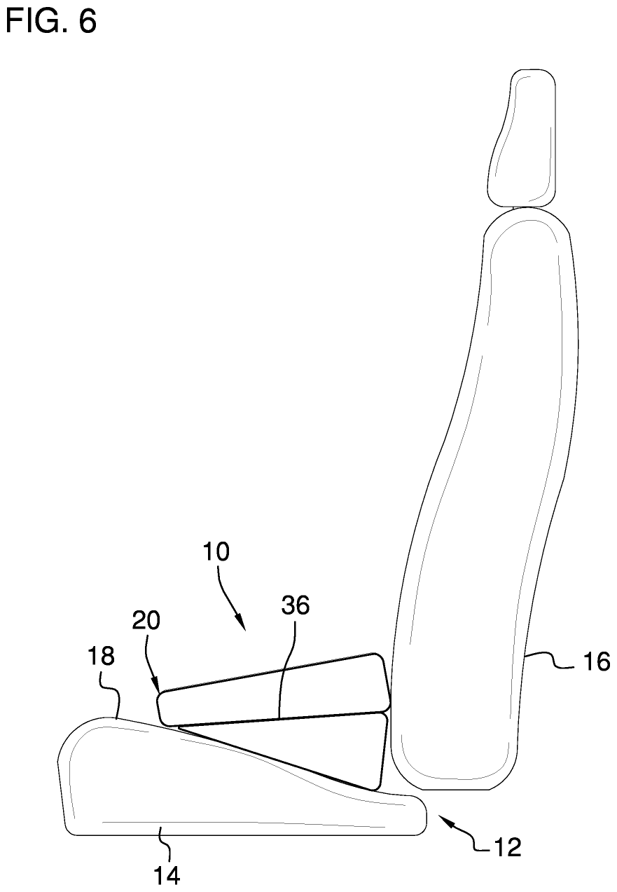

In use, a user of the system 10 will position the cushioning assembly on the seat 14 as shown in FIG. 6 and thereafter sit on the cushioning assembly 20 as opposed to sitting directly on the seat 14. This will position the user's buttocks higher than without the cushioning assembly 20 to decrease the angle formed in the person's legs at their knees. This in turn reduces pressure on the vertebrae of the lower back.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An auxiliary seat cushion system for positioning to increase a height of a person's lower back relative to the person's knees when the person is sitting in a vehicle, said system including:
a chair having a seat and a backrest being attached to and extending upwardly, from the seat, the seat having an upper surface being angled downwardly toward said backrest;
a cushion assembly being positioned on said upper surface of said seat and abutting said backrest, said cushioning assembly having a top side, a front side, a rear side, a first lateral side, a second lateral side and a bottom side, said top side being angled upwardly from said front side to said rear side when said bottom side is abutted against the seat and the rear side is abutted against the backrest, said cushion assembly being resiliently compressible, wherein said cushion assembly has a break therein to define an upper section and a lower section, said break extending through the rear side to a juncture of said front side and said bottom side; and
a coupler releasable coupling a bottom face of said upper section directly- to a top face of said lower section.

2. The auxiliary seat cushion system according to claim 1, wherein said front side has a height from said top side to said bottom side being less than 2.0 inches and said rear side has a height from said top side to said bottom side being greater than 6.0 inches.

3. The auxiliary seat cushion system according to claim 2, wherein a distance from said first lateral side to said second lateral side is between 14.0 inches and 20.0 inches, and a distance from said front side to said rear side is between 11.0 inches and 17.0 inches.

4. The auxiliary seat cushion system according to claim 3, wherein said front side has a pair of concave indentations therein, said concave indentations being laterally spaced from each other and forming concave arcs in each of said top and bottom sides.

5. (canceled)

6. The auxiliary seat cushion system according to claim 1, wherein said rear side of said upper section has a height being, greater than 2.0 inches.

7. (canceled)

8. (canceled)

9. (canceled)

10. (canceled)

11. The auxiliary seat cushion system according to claim 1, wherein said back having a cutout therein extending into said rear side and through said top side, said cutout being equally spaced from said first and second lateral sides, said cutout extending into said rear and top sides and toward said front side a distance of less 4.0 inches, said cutout having a width extending along said rear side being between 2.0 inches and 5.0 inches.

12. The auxiliary seat cushion system according to claim 3, wherein said back having a cutout therein extending into said rear side and through said top side, said cutout being equally spaced from said first and second lateral sides, said cutout extending into said rear and top sides and toward said front side a distance of less 4.0 inches, said cutout having a width extending along said rear side being between 2.0 inches and 5.0 inches.

13. (canceled)

14. An auxiliary seat cushion system for positioning to increase a height of a person's lower back relative to the person's knees when the person is sitting in a vehicle, said system including:
a chair having a seat and a backrest being attached to and extending upwardly from the seat, the seat having an upper surface being angled downwardly toward said backrest;
a cushion assembly being positioned on said upper surface of said seat and abutting said backrest, said cushioning assembly having a top side, a front side, a rear side, a first lateral side, a second lateral side and a bottom side, said top side being angled upwardly from said front side to said rear side when said bottom side is abutted against the seat and the rear side is abutted against the backrest, said cushion assembly being resiliently compressible;
said front side having a height from said top side to said bottom side being less than 2.0 inches;
said rear side having a height from said top side to said bottom side being greater than 6.0 inches;
a distance from said first lateral side to said second lateral side being between 14.0 inches and 20.0 inches, a distance from said front side to said rear side being between 11.0 inches and 17.0 inches;
said front side having a pair of concave indentations therein, said concave indentations being laterally spaced from each other and forming concave arcs in each of said top and bottom sides;
said cushion assembly having a break therein to define an upper section and a lower section, said break extending through rear side to a juncture of said front side and said bottom side, said rear side of said upper section having a height being greater than 2.0 inches;
a coupler releasably coupling a bottom face of said upper section directly to a top face of said lower section; and
a cutout extending into said rear side and through said top side, said cutout being equally spaced from said first and second lateral sides, said cutout extending into said rear and top sides and toward said front side a distance of less 4.0 inches, said cutout having a width extending along said rear side being between 2.0 inches and 5.0 inches.
